(19) United States
(12) Patent Application Publication
(10) Pub. No.: US 2026/0269459 A1
(43) Pub. Date: Sep. 10, 2026

(54) SATELLITE ANTENNA SYSTEM FOR A VEHICLE AND ASSOCIATED METHODS

(71) Applicant: AVIDYNE CORPORATION, Melbourne, FL (US)

(72) Inventor: Daniel SCHWINN, Melbourne Beach, FL (US)

(21) Appl. No.: 19/074,501

(22) Filed: Mar. 10, 2025

(51) Int. Cl. H01Q 1/28; H01Q 1/42

(52) U.S. Cl. CPC H01Q 1/28; H01Q 1/42

(57) ABSTRACT

A satellite antenna system for a vehicle may include a satellite antenna having an antenna housing and antenna circuitry. The antenna housing may have a rectangular shape and opposing front and rear surfaces with the rear surface having an antenna mounting recess. A base may be configured to be mounted to an outer surface of the vehicle. An antenna mount may be carried by the base and extend into the antenna mounting recess to mount the satellite antenna. An antenna locking arrangement may releasably lock the satellite antenna to the antenna mount. An antenna fairing may surround the base with the front surface of the antenna housing being exposed. A fairing locking arrangement may releasably lock the antenna fairing to the base.

### FIELD OF THE INVENTION

The present invention relates to the field of antennas, and, more particularly, to a satellite antenna that may be releasably locked to a vehicle and related methods.

### BACKGROUND OF THE INVENTION

The recent introduction of Low Earth Orbit (LEO) satellite internet constellations that provide satellite internet service, such as the Starlink system operated by Starlink Services, LLC, has created a need for small, portable satellite antennas. These LEO satellite constellations provide low-latency, high bandwidth (broadband) internet service. Similar satellite internet services have been proposed and are being developed by the Chinese National Satellite Internet Project and similar national programs. The portable antennas used to receive signals from these satellite internet constellations usually are small, sometimes about the size of a large laptop, and often provide pass-through for power, ethernet, and WiFi capability.

An example is the Starlink satellite antenna that is a small, rectangular shaped antenna. This antenna has a rear antenna mounting recess similar to a snap-on fitting that allows it to be fixed onto a ground pole mount that allows the antenna to be mounted at a 5° angle of vertical, in an example. Although the Starlink antenna and similar portable antennas may be used in mobile applications while the antenna is in motion, they are not readily mounted onto vehicles, such as aircraft. Installations on aircraft are highly regulated. Even though portable devices have been accepted on aircraft, aircraft mounts should be certified. There are also rivet lines and curved surfaces on an aircraft that make surface mounting on the exterior of the vehicle difficult. The snap-on mounting configuration of the Starlink antenna makes it difficult to form a positive locking arrangement with the surface of a vehicle. Additionally, the forces exerted by the moving air when a vehicle is in motion may require not only that the antenna be securely mounted to the vehicle, but also that any mounting arrangement be aerodynamically configured to reduce the forces imparted by the moving air on the antenna during vehicle movement.

### SUMMARY OF THE INVENTION

A satellite antenna system for a vehicle, such as an aircraft, may comprise a satellite antenna comprising an antenna housing and antenna circuitry carried thereby. The antenna housing may have a rectangular shape and opposing front and rear surfaces. The rear surface may have an antenna mounting recess formed therein. A base may be configured to be mounted to an outer surface of the vehicle. An antenna mount may be carried by the base and configured to extend into the antenna mounting recess to mount the satellite antenna. An antenna locking arrangement may releasably lock the satellite antenna to the antenna mount. An antenna fairing may be configured to surround the base with the front surface of the antenna housing being exposed. A fairing locking arrangement may be configured to releasably lock the antenna fairing to the base.

A plurality of brackets may be carried by the base to secure the base to the vehicle with a gap therebetween. The vehicle may comprise an aircraft having a curved outer surface, and the brackets may be configured to conform to the curved outer surface. The antenna fairing may have rectangular opening for receiving the rectangular satellite antenna therein in a flush configuration.

The antenna locking arrangement may comprise a mount body, at least one locking pawl carried by the mount body, and at least one actuator extending between the mount body and the base and configured to move the at least one locking pawl between released and locked positions. The at least one actuator may comprise at least one threaded rod and a knob coupled thereto. The antenna locking arrangement may comprise a slidable locking member associated with the at least one threaded rod.

The fairing locking arrangement may comprise a pair of locking bars slidably carried by opposite sides of the base and having a plurality of locking projections extending outwardly therefrom. The antenna fairing may comprise a plurality of locking projection receiving features defined therein and cooperating with the plurality of locking projections. The fairing locking arrangement may comprise a release tab coupled to the pair of locking bars and extending outwardly from the antenna fairing.

The antenna circuitry may comprise a satellite receiver, and WiFi circuitry coupled thereto. The satellite antenna may comprise a Starlink antenna.

Another aspect is directed to a vehicle antenna mounting kit for a satellite antenna that may comprise an antenna housing and antenna circuitry carried thereby. The antenna housing may have a rectangular shape and opposing front and rear surfaces. The rear surface may have an antenna mounting recess formed therein. The vehicle antenna mounting kit may comprise a base configured to be mounted to an outer surface of the vehicle, an antenna mount carried by the base and configured to extend into the antenna mounting recess to mount the satellite antenna, and an antenna locking arrangement to releasably lock the satellite antenna to the antenna mount. An antenna fairing may be configured to surround the base with the front surface of the antenna housing being exposed. A fairing locking arrangement may be configured to releasably lock the antenna fairing to the base. A fairing replacement cover may be configured to replace the antenna fairing and be releasably locked to the base when the satellite antenna is removed.

A method aspect is directed to a method for mounting a satellite antenna to a vehicle. The satellite antenna may comprise an antenna housing and antenna circuitry carried thereby. The antenna housing may have a rectangular shape and opposing front and rear surfaces. The rear surface may have an antenna mounting recess formed therein. The method may comprise mounting a base to an outer surface of the vehicle, and releasably locking the satellite antenna to an antenna mount using an antenna locking arrangement by positioning an antenna mount carried by the base into the antenna mounting recess. The method further includes releasably locking an antenna fairing to surround the base using a fairing locking arrangement so that the front surface of the antenna housing is exposed, and using a fairing replacement cover to replace the antenna fairing and be releasably locked to the base when the satellite antenna is removed.

### BRIEF DESCRIPTION OF THE DRAWINGS

Other objects, features and advantages of the present embodiments will become apparent from the Detailed Description of the invention which follows, when considered in light of the accompanying drawings in which:

FIG. 1 in an environmental view of the satellite antenna system mounted on an aircraft as an example vehicle in accordance with an embodiment.

FIG. 2 is an isometric view of the antenna satellite system of FIG. 1 showing the antenna fairing and exposed front surface of the satellite antenna.

FIG. 3 is a phantom view of the satellite antenna system of FIG. 2 showing the base, antenna mount, antenna locking arrangement, and fairing locking arrangement.

FIG. 4 is a reverse phantom view of the satellite antenna system similar to the view of FIG. 3, but without the antenna fairing.

FIG. 5 is an exploded isometric view of the satellite antenna system.

FIG. 6 is a top isometric view of the fairing replacement cover that replaces the antenna fairing when the satellite antenna is removed.

FIG. 7 is a high-level flowchart of a method for mounting a satellite antenna to a vehicle using the satellite antenna system.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

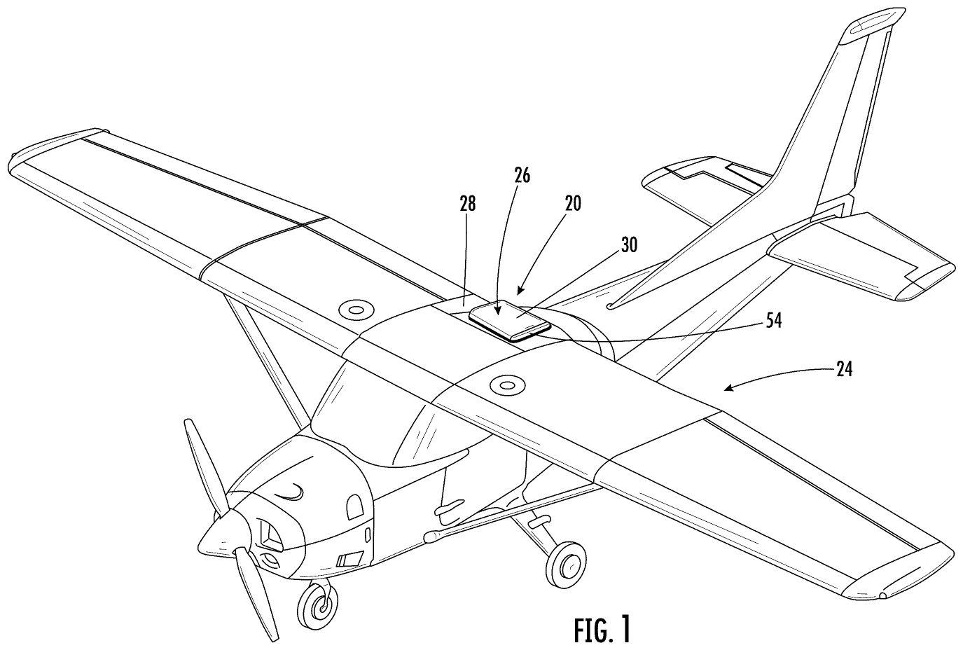

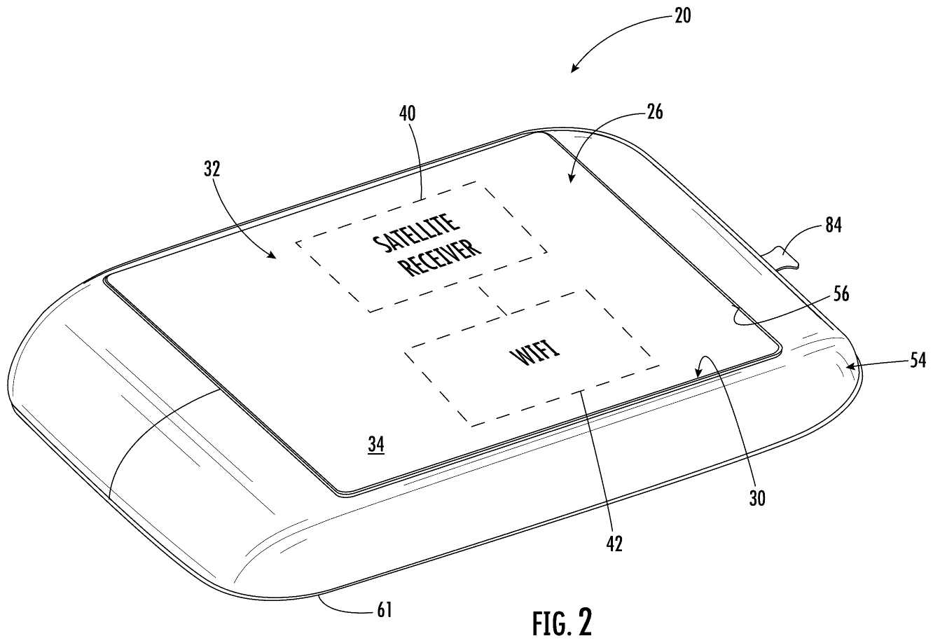

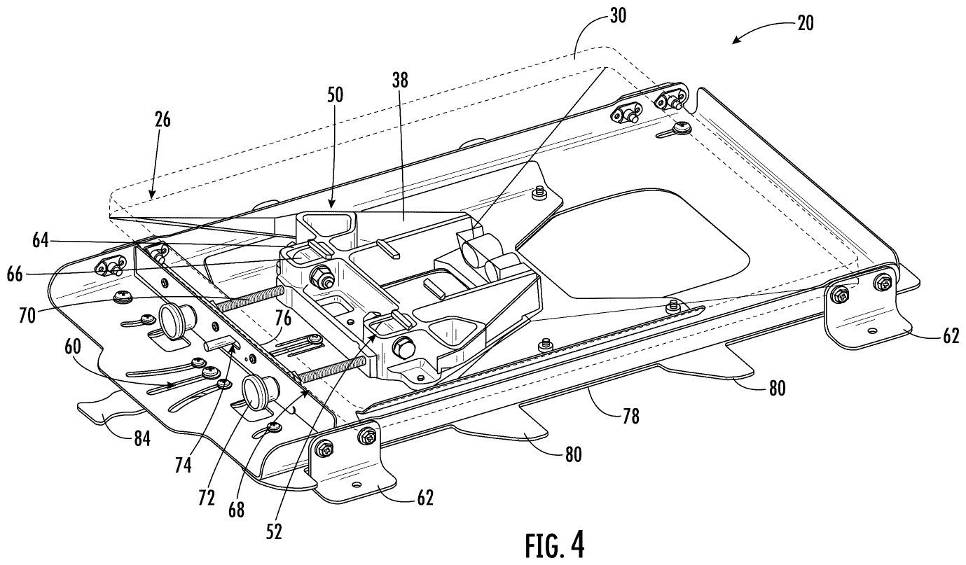

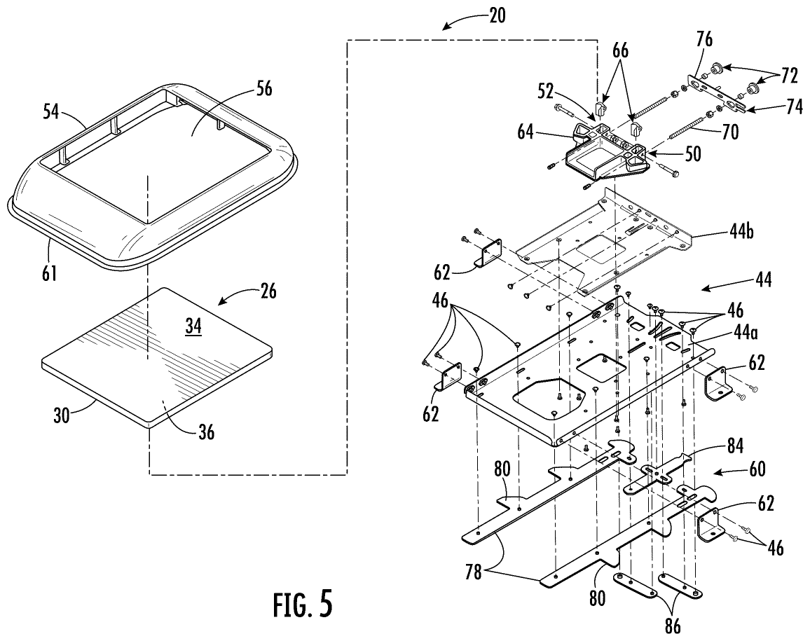

Referring now to FIGS. 1-5, there is illustrated generally at 20 the satellite antenna system for a vehicle 24, illustrated as an aircraft in FIG. 1. In this example, the satellite antenna 26 as part of the satellite antenna system 20 is fixed to the curved outer surface of the fuselage 28 of the vehicle 24 above the cockpit of the aircraft. The satellite antenna 26 includes an antenna housing 30 and antenna circuitry 32 carried thereby (FIG. 2). The antenna housing 30 has a rectangular shape and opposing front and rear surfaces 34,36 (FIG. 5). An antenna mounting recess 38 is formed in the rear surface 36 as perhaps best shown in the phantom view of FIG. 4. This antenna mounting recess 38 is similar in configuration to the mounting recess used in the Starlink mini antenna manufactured by Starlink Services, LLC. However, different configurations of antenna mounting recesses 38 may be used.

In the example satellite antenna 26 shown in FIG. 2, the antenna circuitry 32 may include a satellite receiver 40 and WiFi circuitry 42 coupled thereto as schematically shown by the dashed outline for these components. The satellite antenna 26 may be about 10 inches to about 12 inches in a rectangular configuration, and about 1.5 inches thick, corresponding in this example for the Starlink mini antenna, which is roughly half the size and one-third the weight of a Starlink standard antenna. Although the Starlink mini antenna is described, other similar configured portable antennas may be used for the satellite antenna system 20 to mount the satellite antenna 26 onto a vehicle 24. Although a rectangular configuration for the satellite antenna 26 is shown and described, the antenna may have other configurations and shapes different from a rectangular configuration.

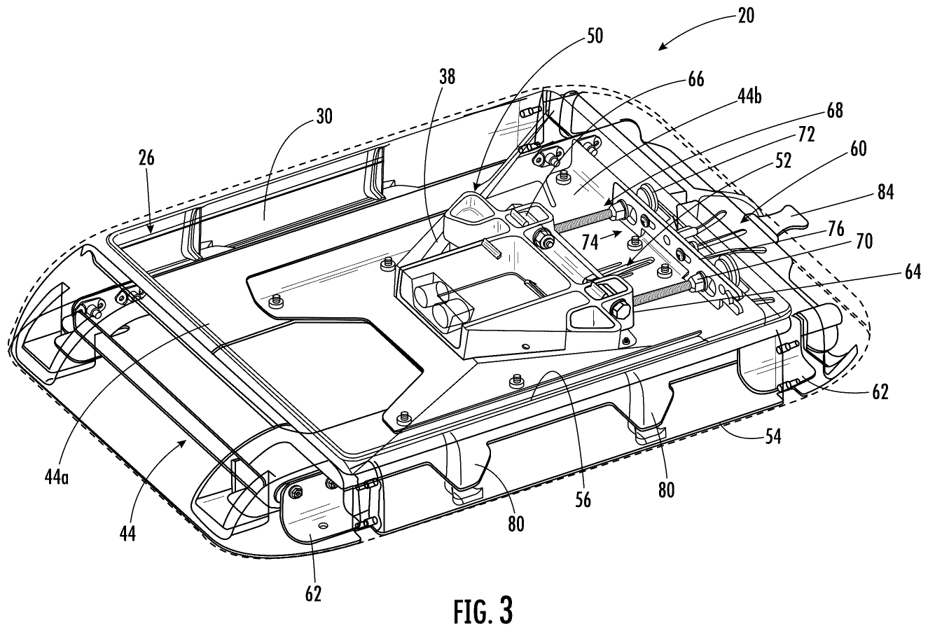

As shown in the phantom views of FIGS. 3 and 4, and the exploded isometric view of FIG. 5, a base 44 is configured to be mounted to an outer surface of the vehicle 24, e.g., the aircraft in FIG. 1. The base 44 is formed from two sections in this example, i.e., a lower base member 44a formed as a rectangular configured tray and upper tray support 44b secured by screws 46 to the lower base member. An antenna mount 50 is carried by the base 44, e.g., on top of the upper tray support 44b and secured by screws 46, and configured to extend into the antenna mounting recess 38 at the rear surface 36 of the satellite antenna 26 to secure the antenna in a fixed position.

An antenna locking arrangement 52 releasably locks the satellite antenna 26 to the antenna mount 50. An antenna fairing 54 is configured to surround the base 44 with the front surface 34 of the antenna housing being exposed. The antenna fairing 54 has a rectangular opening 56 for receiving the rectangular configured satellite antenna 26 in a flush configuration (FIG. 2). A fairing locking arrangement 60 is configured to releasably lock the antenna fairing 54 to the base 44. A fairing gasket seal 61 is positioned at the peripheral lower edge of the antenna fairing 54 to seal the antenna fairing against the outer surface of the vehicle 24 when installed.

A plurality of brackets 62 are carried by the base 44, and in this example, the lower base member 44a, to secure the base to the vehicle 24 with a gap therebetween. Four brackets 62 are carried at each corner of the base 44. The vehicle 24 as noted before illustratively has a curved outer surface, and the brackets 62 are configured to conform to the curved outer surface. In the illustrated example, the brackets 62 are formed as L brackets, also termed angle or corner brackets, and secured to a side flange of the lower base member 44a by screws 46. The brackets 62 may be bent slightly to adjust the positioning of the base 44 relative to the curved outer surface of the vehicle 24. A spacer gasket (not shown) may be positioned under the brackets 62 against the outer surface of the vehicle 24 and also help conform the brackets to the curved outer surface of the vehicle 24. The brackets 62 may be secured to the outer surface of the vehicle 24 by screws 46 or other similar fasteners.

The antenna locking arrangement 52 releasably locks the satellite antenna 26 to the antenna mount 50 and includes a mount body 64, and at least one locking pawl 66 carried by the mount body. At least one actuator 68 extends between the mount body 64 and the base 44 and is configured to move the at least one locking pawl 66 between the released and locked positions so that the satellite antenna 26 may be locked and secured to the mount body or unlocked and removed. The at least one actuator 68 includes at least one threaded rod 70 and a knob 72 coupled thereto. The antenna locking arrangement 52 includes a slidable locking member 74 associated with the at least one threaded rod 72.

In the example shown in FIGS. 3-5, the mount body 64 is trapezoidal shaped similar to a wedge that is configured to fit within the antenna mounting recess 38, which in this example is a trapezoidal configured recess common in the Starlink mini antenna. Two locking pawls 66 are carried by the mount body 64, and each includes an associated actuator 68 as a threaded rod 70 supported by a rear flange at the upper tray support 44b. Each threaded rod 70 extends into the mount body 64 and engages the locking pawls 66. As the knobs 72 are rotated, each locking pawl 66 is rotated slightly to extend a protrusion on the respective locking pawl against the antenna mounting recess 38 on the satellite antenna 26 and lock the antenna in position against the mount body 64. The slidable locking member 74 includes a knob lock bar 76 (FIG. 5) that may slide relative to the base 44 and mount body 64, and more particularly, laterally relative to the tray support 44b to engage the knobs 72 and threaded rods 70 and prevent their rotation, and thus, maintain the locking pawl 66 in a locked position against the antenna. The knob lock bar 76 may be slid in reverse to allow the knob 72 to be turned and move the locking pawls 66 into their released position, and the satellite antenna 26 would no longer be locked to the mount body 64.

The fairing locking arrangement 60 includes a pair of locking bars 78 that are slidably carried on opposite sides of the lower section of the base 44. Each locking bar 78 includes a plurality of locking projections 80 that extend outwardly therefrom in the form of triangular configured tabs. As perhaps best shown in the phantom view of FIG. 3, the antenna fairing 54 includes a plurality of locking projection receiving features 82 along the underside of its outer perimeter that cooperate with the plurality of locking projections 80. The fairing locking arrangement 60 includes a release tab 84 coupled to the pair of locking bars 78. The release tab 84 extends outward from the antenna fairing 54 and is coupled to the pair of locking bars 78 via dual lever arms 86 (FIG. 5). When the release tab 84 is pulled, the locking bar projections 80 slide out of engagement with the locking projection receiving features 82 to release the antenna fairing 54. When pushed in, the antenna fairing 54 is locked relative to the satellite antenna 26, the mount body 64 and vehicle 24.

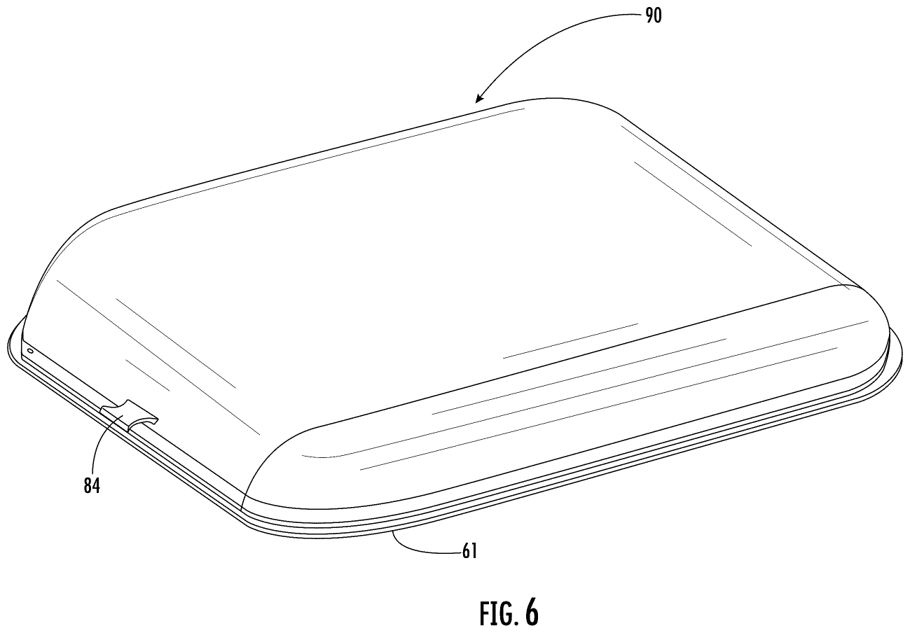

The antenna housing 30, the base 44, the antenna mount 50, the antenna locking arrangement 52, the antenna fairing 54 and associated fairing locking arrangement 60 may be packaged as a vehicle antenna mounting kit that includes a fairing replacement cover 90 (FIG. 6) that is configured to replace the antenna fairing 54 and be releasably locked to the base 44 when the satellite antenna 26 is removed. This is advantageous when the satellite antenna 26 is removed from the mount body 64, and the antenna used elsewhere, such as in another vehicle 24 or for home use. When the antenna fairing 54 and the satellite antenna 26 are removed, the other components forming the vehicle antenna mounting kit, i.e., the base 44, antenna mount 50, antenna locking arrangement 52, and fairing locking arrangement 60 are not removed from the vehicle 24 since those components are securely attached to the vehicle. For example, on the illustrated vehicle 24 as the aircraft of FIG. 1, if the satellite antenna 26 and antenna fairing 54 are removed, the fairing replacement cover 90 may replace the antenna fairing 54 and may be releasably locked to the base 44 to provide an aerodynamically configured cover over the base, antenna mount 50, antenna locking arrangement 52, and fairing locking arrangement 60.

When installing the satellite antenna system 20, there is limited penetration of the outer surface of the vehicle 24, such as the aircraft fuselage 28. Limiting the amount of outer surface penetration of the vehicle 24 may be important in some applications, e.g., an aircraft, where Federal Aviation Administration (FAA) guidelines are strict on what modifications can be made to the aircraft fuselage 28.

As shown in FIGS. 3-5, only four mounting holes are made in the outer surface of the vehicle 24 to receive screws 46 that secure the brackets 62 and base 44 to the outer surface of the vehicle, in this example, the aircraft. One central wiring hole may be made in the outer surface through which any power and optional ethernet cables may be guided. The base 44 and other components may be made from aluminum or other similar metallic materials. The antenna fairing 54 may be made from similar metallic materials or a rigid plastic. As noted above, installations on aircraft are highly regulated. The satellite antenna system 20 is an example of a certified mount on the exterior of an aircraft 24 that enables use of a non-certified removable portable device, in this example, the satellite antenna 26.

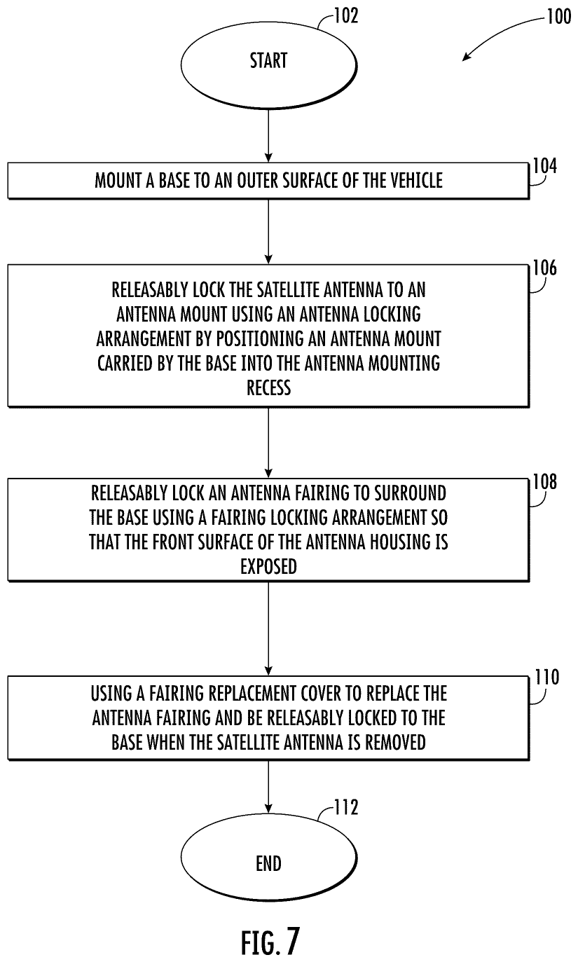

Referring now to FIG. 7, a method for mounting a satellite antenna 26 to a vehicle 24 is shown generally by the flow diagram at 100. The method starts (Block 102) and the base 44 is mounted to an outer surface of the vehicle 24 (Block 104). The satellite antenna 26 is releasably locked to the antenna mount 50 using the antenna locking arrangement 52 by positioning the antenna mount 50 carried by the base 44 into the antenna mounting recess 38 (Block 106). The antenna fairing 54 is releasably locked around the antenna 26 and base 44 using a fairing locking arrangement 60 so that the front surface of the antenna housing 30 is exposed (Block 108). A fairing replacement cover 90 is used to replace the antenna fairing 54 and is releasably locked to the base 44 when the satellite antenna 26 is removed (Block 110). The process ends (Block 112).

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A satellite antenna system for a vehicle comprising:
a satellite antenna comprising an antenna housing and antenna circuitry carried thereby, the antenna housing having a rectangular shape, and opposing front and rear surfaces, the rear surface having an antenna mounting recess formed therein;
a base configured to be mounted to an outer surface of the vehicle;
an antenna mount carried by the base and configured to extend into the antenna mounting recess to mount the satellite antenna;
an antenna locking arrangement to releasably lock the satellite antenna to the antenna mount;
an antenna fairing configured to surround the base with the front surface of the antenna housing being exposed; and
a fairing locking arrangement configured to releasably lock the antenna fairing to the base.

2. The satellite antenna system of claim 1 comprising a plurality of brackets carried by the base to secure the base to the vehicle with a gap therebetween.

3. The satellite antenna system of claim 2 wherein the vehicle comprises an aircraft having a curved outer surface; and wherein the brackets are configured to conform to the curved outer surface.

4. The satellite antenna system of claim 1 wherein the antenna fairing has rectangular opening for receiving the rectangular satellite antenna therein in a flush configuration.

5. The satellite antenna system of claim 1 wherein the antenna locking arrangement comprises:
a mount body;
at least one locking pawl carried by the mount body; and
at least one actuator extending between the mount body and the base and configured to move the at least one locking pawl between released and locked positions.

6. The satellite antenna system of claim 5 wherein the at least one actuator comprises at least one threaded rod and a knob coupled thereto; and wherein the antenna locking arrangement comprises a slidable locking member associated with the at least one threaded rod.

7. The satellite antenna system of claim 1 wherein the fairing locking arrangement comprises a pair of locking bars slidably carried by opposite sides of the base and having a plurality of locking projections extending outwardly therefrom; and wherein the antenna fairing comprises a plurality of locking projection receiving features defined therein and cooperating with the plurality of locking projections.

8. The satellite antenna system of claim 7 wherein the fairing locking arrangement comprises a release tab coupled to the pair of locking bars and extending outwardly from the antenna fairing.

9. The satellite antenna system of claim 1 wherein the antenna circuitry comprises a satellite receiver, and WiFi circuitry coupled thereto.

10. The satellite antenna system of claim 1 wherein the satellite antenna comprises a Starlink antenna.

11. A vehicle antenna mounting kit for a satellite antenna comprising an antenna housing and antenna circuitry carried thereby, the antenna housing having a rectangular shape, and opposing front and rear surfaces, the rear surface having an antenna mounting recess formed therein, the vehicle antenna mounting kit comprising:
a base configured to be mounted to an outer surface of the vehicle;
an antenna mount carried by the base and configured to extend into the antenna mounting recess to mount the satellite antenna;
an antenna locking arrangement to releasably lock the satellite antenna to the antenna mount;
an antenna fairing configured to surround the base with the front surface of the antenna housing being exposed;
a fairing locking arrangement configured to releasably lock the antenna fairing to the base; and
a fairing replacement cover configured to replace the antenna fairing and be releasably locked to the base when the satellite antenna is removed.

12. The vehicle antenna mounting kit of claim 11 comprising a plurality of brackets carried by the base to secure the base to the vehicle with a gap therebetween.

13. The vehicle antenna mounting kit of claim 12 wherein the vehicle comprises an aircraft having a curved outer surface; and wherein the brackets are configured to conform to the curved outer surface.

14. The vehicle antenna mounting kit of claim 11 wherein the antenna fairing has rectangular opening for receiving the rectangular satellite antenna therein in a flush configuration.

15. The vehicle antenna mounting kit of claim 11 wherein the antenna locking arrangement comprises:
a mount body;
at least one locking pawl carried by the mount body; and
at least one actuator extending between the mount body and the base and configured to move the at least one locking pawl between released and locked positions.

16. The vehicle antenna mounting kit of claim 15 wherein the at least one actuator comprises at least one threaded rod and a knob coupled thereto; and wherein the antenna locking arrangement comprises a slidable locking member associated with the at least one threaded rod.

17. The vehicle antenna mounting kit of claim 11 wherein the fairing locking arrangement comprises a pair of locking bars slidably carried by opposite sides of the base and having a plurality of locking projections extending outwardly therefrom; and wherein the antenna fairing comprises a plurality of locking projection receiving features defined therein and cooperating with the plurality of locking projections.

18. The vehicle antenna mounting kit of claim 17 wherein the fairing locking arrangement comprises a release tab coupled to the pair of locking bars and extending outwardly from the antenna fairing.

19. A method for mounting a satellite antenna to a vehicle, the satellite antenna comprising an antenna housing and antenna circuitry carried thereby, the antenna housing having a rectangular shape, and opposing front and rear surfaces, the rear surface having an antenna mounting recess formed therein, the method comprising:
mounting a base to an outer surface of the vehicle;
releasably locking the satellite antenna to an antenna mount using an antenna locking arrangement by positioning an antenna mount carried by the base into the antenna mounting recess;
releasably locking an antenna fairing to surround the base using a fairing locking arrangement so that the front surface of the antenna housing is exposed; and
using a fairing replacement cover to replace the antenna fairing and be releasably locked to the base when the satellite antenna is removed.

20. The method of claim 19 comprising securing the base to the vehicle with a gap therebetween using a plurality of brackets.

21. The method of claim 20 wherein the vehicle comprises an aircraft having a curved outer surface; and wherein the brackets are configured to conform to the curved outer surface.

22. The method of claim 19 wherein the antenna fairing has rectangular opening for receiving the rectangular satellite antenna therein in a flush configuration.

23. The method of claim 19 wherein the antenna locking arrangement comprises:
a mount body;
at least one locking pawl carried by the mount body; and
at least one actuator extending between the mount body and the base and configured to move the at least one locking pawl between released and locked positions.

24. The method of claim 23 wherein the at least one actuator comprises at least one threaded rod and a knob coupled thereto; and wherein the antenna locking arrangement comprises a slidable locking member associated with the at least one threaded rod.

25. The method of claim 19 wherein the fairing locking arrangement comprises a pair of locking bars slidably carried by opposite sides of the base and having a plurality of locking projections extending outwardly therefrom; and wherein the antenna fairing comprises a plurality of locking projection receiving features defined therein and cooperating with the plurality of locking projections.

26. The method of claim 25 wherein the fairing locking arrangement comprises a release tab coupled to the pair of locking bars and extending outwardly from the antenna fairing.

27. The method of claim 19 wherein the antenna circuitry comprises a satellite receiver, and WiFi circuitry coupled thereto.

28. The method of claim 19 wherein the satellite antenna comprises a Starlink antenna.
